(19) United States
(12) Patent Application Publication
(10) Pub. No.: US 2013/0137056 A1
(43) Pub. Date: May 30, 2013

(54) HEAT CHAMBER

(71) Applicants: David Vardy, Berkeley, CA (US); Dave Condon, Livermore, CA (US)

(72) Inventors: David Vardy, Berkeley, CA (US); Dave Condon, Livermore, CA (US)

(21) Appl. No.: 13/688,154

(22) Filed: Nov. 28, 2012

Related U.S. Application Data
(60) Provisional application No. 61/564,217, filed on Nov. 28, 2011.

(51) Int. Cl. F27D 1/00; F27D 1/06

(52) U.S. Cl. CPC F27D 1/0006; F27D 1/06
USPC 432/247; 110/338

(57) ABSTRACT

A heat chamber having multiple segments formed from castable material.

### PRIORITY APPLICATION

This application claims benefit of priority to Provisional U.S. Patent Application No. 61/564,217, filed Nov. 28, 2011 entitled HEAT CHAMBER; the aforementioned priority application being hereby incorporated by reference in its entirety.

### TECHNICAL FIELD

The disclosed embodiments relate to a heat chamber, such as an oven or kiln.

### BACKGROUND

Many conventional ovens and kilns operate in principal by blasting gases within a chamber, resulting in the walls of the chamber becoming heated. Pizza ovens, for example, distribute heat internally with little consideration for maximize heat retention and/or minimize fuel requirements. The result is that such ovens are inefficient, expensive and emit harmful gases and chemicals.

### BRIEF DESCRIPTION OF THE DRAWINGS

FIG. 1A illustrates a basic heat chamber design in accordance with one or more embodiments.

FIG. 1B is an example cross-section of a chamber such as described with FIG. 1A and elsewhere in this application.

FIG. 1C is a cross-sectional illustration of a heating chamber, according to one or more embodiments.

FIG. 2 is a side view of the heat source 130, according to one or more embodiments.

FIG. 3 illustrates a control system for a combustor such as shown and described with FIG. 1 and FIG. 2, according to another embodiment.

FIG. 4A is a top view of a solenoid structure for use as a heating source, according to an embodiment.

FIG. 4B is a side cross-sectional view of the solenoid structure of FIG. 4A, as viewed along A-A.

### DETAILED DESCRIPTION

Embodiments described herein include a heat chamber that creates and guides hot gas flow to maximize absorption of resulting heat, and to increase efficiency at radiating absorbed heat, thus increasing efficiency and effectiveness.

Embodiments described herein include heat chamber formed from a plurality of monolithic pieces. Each of the monolithic pieces may be comprised of castable material.

In another embodiment, a segment is provided for a heat chamber. The segment is formed from a castable material comprising a composite, one or more layers of insulation, and an exterior skin.

According to some embodiments, heat chamber includes a plurality of segments that define an interior and a heat source to heat an interior of the interior. Each of the plurality of segments may be formed from a composite that is able to be heated, substantially across a thickness of that segment, to a temperature that is substantially equivalent to a temperature of the interior when the interior is heated by the heat source.

According to some embodiments, a heat chamber is provided that is configured to mix and distribute heated gas in a manner that increases efficiency and performance.

In an embodiment, a heat chamber is provided that includes a heat source and a platform. The heat source is positioned within a base region, and the platform is positioned over the heat source so as to extend across at least a substantial portion of the heating space. The platform is dimensioned or shaped to include one or more gap formations that are formed with a sidewall of an interior of the heat chamber. The platform is structured to force a gas flow, generated as output from the heat source to flow, upward through the gap formation so as to turbulize the gas flow within the interior.

A heat chamber such as shown and described by various embodiments may be implemented for a variety of applications, such as food preparation or industrial applications. As a specific example, a heat chamber such as shown and described by some embodiments may be implemented as a general purpose restaurant oven that can prepare a diverse range of food items at various temperatures. As an alternative or addition, a heat chamber as shown and described may be implemented as a pizza oven or baking oven. In industrial applications, a heat chamber 100 such as shown and described may be used to heat industrial materials, such as plastics, resins, or semi conductive materials.

Embodiments described herein include numerous design enhancements to conventional oven chamber design. Among them, a heat chamber is provided that is capable of a diverse temperature range, while operating at an efficiency that exceeds conventional designs. Still further, the interior of the heat chamber is capable of achieving even high temperatures in a relatively short time, particularly as compared to conventional ovens. Still further, at least some embodiments include a control system that enables an operator to achieve desired temperatures with precision and robustness. Numerous other benefits will be apparent from the description provided below.

Still further, in some embodiments, a heat chamber is provided that includes a plurality of segments that define an interior. A heat source is provided to heat the interior. Each of the plurality of segments are formed from a composite that is able to be heated, substantially across a thickness of that segment, to a temperature that is substantially equivalent to a temperature of the interior when the interior is heated by the heat source.

### Material and Manufacturing Process

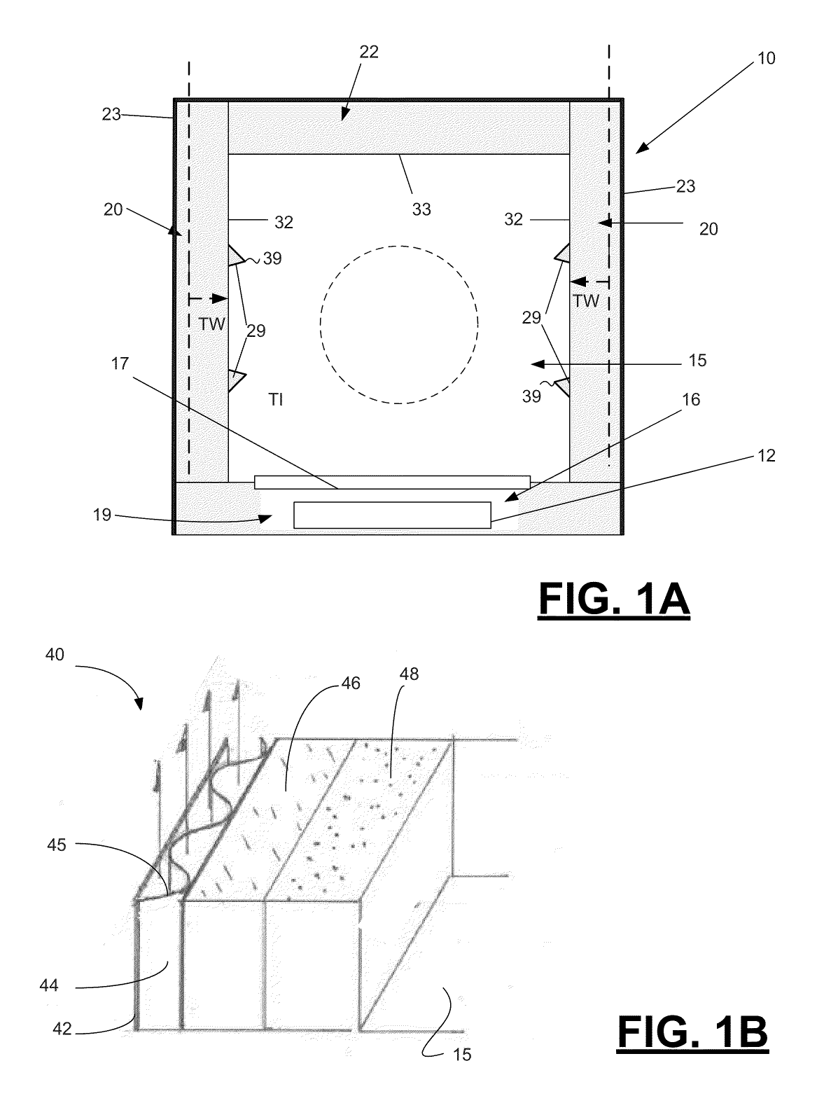

FIG. 1A illustrates a basic heat chamber design in accordance with one or more embodiments. A heat chamber 10 includes a heat source 12 that is capable of heating an interior 15 of the chamber to a desired temperature. The heat source 12 can correspond to a combustion heater, such as a gas-fueled burner as described with an example of FIG. 1B. As an alternative or variation, the heat source 12 can correspond to an electrical heater. The positioning of the heat source 12 within the heat chamber 10 can be varied based on design implementation. In an example of FIG. 1A, the heat source 12 is positioned within a base region 16 of the interior 15, and more specifically within a base center region of the interior 15. A flooring 17 can separate a portion of the interior where, for example, items are cooked from the region where the heat source 12 is located.

In one implementation, the heat source 12 can include multiple elements that are distributed within the base region 16. For example, in an implementation in which the base region 16 is electrical, one or more elements of the electrical heater can be distributed within the base region. For example, the heating element can correspond to a sinusoidal element positioned at the base region 16.

The chamber 10 includes perimeter segments 20, 22 which can define a shape and dimension of the interior 15, as well as the exterior of the heat chamber 10. Each perimeter segment 20, 22 can comprise a castable and monolithic thickness comprising a composite with desired characteristics as described below. As used herein, “castable” refers to a segment that is formed from a mold, using a composite of material that is uniformly distributed in the mold and shaped in accordance with the mold. As described by some examples, the castable portions of the respective segments 20, 22 can form an interior thickness of the particular segment.

In FIG. 1A, a structure 23 can optionally be provided to form a frame or structure of the segments 20, 22. The interior 15 can, for example, be rectangular, oval or circular or domed (rectangular with rounded ceiling). The perimeter segments 20, 22 include an interior thickness 32, 33 which provide the walls for the interior 15. As described with an example of FIG. 1B, the thickness 32, 33 can be formed from castable material that can heat substantially uniformly to be substantially equivalent to the temperature of the interior 15 of the chamber 10.

According to some embodiments, the perimeter segments 20, 22 can be formed of material and in accordance with a design that enables a heating (e.g., cooking) environment in which at least the interior sidewalls 32 (and optionally the interior ceiling 33) of the heat chamber 10 irradiate at a temperature that is substantially equivalent to the ambient heated temperature. By substantially equivalent, it is meant that two stated values can be within 75% of one another and optionally within 10% or even approximately the same value (i.e., two values within 5% of one another). For example, the heat source 12 can heat the interior 15 to 500° F. (−9.444 to 260 degree Celsius), and as a result of the composition and design, the sidewalls 32 may heat to a temperature of 425° F. (218.3 degree Celsius), or more optimally, 490-500° F. (254.4-260 degree Celsius). In one implementation, all perimeter walls of the interior 15 heat to substantially equivalent temperatures. However, some variations may exist as between the perimeter walls 32, 33. For example, a back perimeter wall, or the ceiling wall 33 may heat less or more slowly than sidewalls 32.

With reference to FIG. 1A, when the oven is operational, the temperature of the wall (TW) is substantially equivalent to the temperature of the interior 15 (TI) when TI reaches a steady-state. Moreover, TW can be represented as a gradient across a thickness that serves to irradiate heat. The composition of the sidewalls 32 (or other perimeter walls 15) can be such that across the thickness, TW can decrease. In one implementation, the decrease is less than 10 C per inch of thickness.

Among other benefits, embodiments recognize that, in a food preparation environment, when food is heated in an environment in which the ambient heated temperature is substantially the same as the temperature of an irradiating heat source, food (such as meat) can cook from the inside and outside at the same time, so that, for example, meat is uniformly cooked as between exterior and interior. This can produce more favorable or juicy cooked meats. Additionally, the time for food to cook is significantly reduced.

According to embodiments, heat chamber 100 is formed from monolithic casted segments that are coupled to one another to form the chamber. In an embodiment such as shown, the chamber 100 includes segments corresponding to two or more sides, a back, a front (and/or) a door, a shelf and a ceiling. Each of these sides may be provided by way of a monolithic piece, formed from casting material into a suitably shaped mold.

According to some embodiments, the composition of the materials provide for the castable segments to form a heat chamber 100 that has at least some of the following characteristics: (i) resistant to thermal shock; (ii) able to heat quickly; (iii) able to retain heat; and (iv) minimizes the presence of moisture during the manufacturing process. Accordingly, the primary or key constituents of the composition can include materials that have a relatively low thermal coefficient of expansion. In one implementation, a primary constituent (or set of constituents) of the composition uses to form the segments of the heat chamber 100 can have a characteristic thermal coefficient of expansion of between 0.5-1.0×10 EXP−6/° C. Additionally, a thermal conductivity of the primary constituent (or set of constituents) can be in the range of 1.0 to 1.5, such as about 1.2 or 1.3.

In one embodiment, a refractory castable material is poured into the molds for each of the segments of the heat chamber. In one implementation, the refractory castable material can be formed from a combination of cement binders, aggregates, and polymer additives. Cement binders can include calcium aluminate, colodial silica, sodium silicate, calcium phosphate, or magnesia-phosphate. Aggregates can include mullite, fused or amorphous silica, silica fume, basalt, sillimanite, corundum, or vermiculite. Additional additives include austenite and some organic polymers. Such additives improve the rheological properties of castable material during a mixing process (described below). By weight, the composition of the monolithic pieces includes: 50-99% cement binder and aggregates, and 0-5% polymer additives. In one implementation, the mixture is about 88-90% (by weight) calcium aluminate cement, 8-10% silica fume (by weight), and 0.1-1% (by weight) polymer additives (e.g. CASTAMENT FS20, manufactured by BASF CONSTRUCTION POLYMERS GMBH). In another implementation, the composition of the monolithic pieces include 75-85% amorphous silica, 15-25% cement, and additives such as austenite.

A process for forming the individual monolithic castings includes mixing the dry ingredients with water, using a mixer. The material can be mixed for several minutes (e.g., 5 minutes). The mixed formulation can be poured into a mold (e.g., mold for sidewall, back, shelf, ceiling etc.). The molds can be subjected to vibration, and then allowed to cure over the course of several days. The cured material is then removed from the mold and dried.

The castings may be structured to include fasteners, such as tongue and groove fasteners, which secure the pieces to one another after the individual pieces are formed. The castings may be encased with, for example, stainless steel casing. An additional layer of insulative material may be placed between the stainless steel casing and the casting and assembled into an over or other heat chamber.

According to some embodiments, additional structural elements can be used within the interior 15 to enhance cooking or heating. In one embodiment, structures can be included to orient radiation from a heated source (e.g., sidewalls 32 and/or ceiling wall 33) inward, towards the center of the interior 15 (or where the item being cooked or heated is provided).

Some embodiments provide for sidewalls 32 to include structural features 40 that serve to orient or direct radiation when the walls are heated. In one embodiment, the structural features 29 include a base 19 and lip 39 which has a directional orientation towards a center of the interior 15.

FIG. 1B is an example cross-section of a chamber such as described with FIG. 1A and elsewhere in this application. In particular, a cross section 40 such as shown by FIG. 1B can be implemented for any of the sidewalls 20, 22 of chamber 10. Thus, for example, the cross-section 40 can represent the construction of any of the sidewalls 20, 22 of the chamber 10.

According to some embodiments, the cross-section 40 includes a skin 42, a ventilation thickness 44, one or more insulation layers 46, and the castable thickness 48. The skin 42 provides an exterior frame for the particular segment. In particular, the chamber 10 can be operated in a commercial environment at temperatures of 700-1000° F. (371.1-537.8 degree Celsius). As described with an example of FIG. 1A, a temperature of the castable thickness 48 can be substantially uniform or equivalent across its thickness, so as to match (or be substantially equivalent to) a temperature of the interior 15. Examples described herein recognize that safety concerns, as well as governmental restrictions may preclude the skin 42 from reaching temperatures in excess of, for example, 200° F. (93.33 degree Celsius), or 150° F. (65.56 degree Celsius), 140° F. (60 degree Celsius). Thus, a significant temperature variation may be required when the chamber 10 is in operation, as the castable thickness 48 may operate at a temperature that is several hundred degrees greater than the desired temperature of the skin 42 (e.g., 800° F. (426.7 degree Celsius) 900° F. (482.2 degree Celsius) or 1000° F. (537.8 degree Celsius)).

In an embodiment, the temperature variation can be achieved using a combination of the ventilation thickness 44 and the one or more insulation layers 46. The ventilation thickness 44 can enable the passage of airflow so as to facilitate cooling as between the insulation layer 46 and the skin 42. The insulation layer 46 can promote cooling as between the castable thickness 48 and the skin 42. Within the ventilation thickness 44, the airflow can be forced (e.g., using a blower) or passive, depending on the implementation. In one implementation, the ventilation thickness 44 is created using a shaped element 45 or series of elements, such as a length of corrugated metal. In this way, the shaped element 45 can create separation between the exterior skin 42 and the insulation layer 46.

### Operation and Design

FIG. 1C is a cross-sectional illustration of a heating chamber, according to one or more embodiments. A heat chamber 100 such as described can be fabricated using materials (e.g., castable material) and processes such as described with an embodiment of FIG. 1A. Accordingly, in some embodiments, heat chamber 100 is formed from materials and designs that achieve objectives such as described with an embodiment of FIG. 1A. For example, the heat chamber 100 can include sidewalls or other segments that retain and radiate heat at a temperature that is substantially equivalent to the heated ambient temperature.

In one embodiment, the heat chamber 100 is formed from monolithic pieces, each of which include castable material as described above. Furthermore, embodiments provide that the heat chamber 100 can have a variety of applications and uses, including for the use of cooking or food preparation. For example, the heat chamber 100 may be implemented as her pizza oven, baking oven, and/or general-purpose restaurant oven. In alternative variations, the heat chamber 100 can be implemented as an industrial oven for heating industrial materials.

With reference to FIG. 1C, the heat chamber 100 includes a structure 110 that confines an interior heating space 112. The structure includes a ceiling 121, sidewalls 122 and a base region 124. The structure 110 and/or the interior heating space 112 can be of a variety of geometries, depending on the application and use intended for the heat chamber. For example, while FIG. 1C illustrates heating space 112 in a rectangular configuration, other variations may use a contoured or spherical interior. Numerous such variations are possible.

In an embodiment, a heat source 130 is disposed within the base region 124. The heat source 130 may correspond to a burner that emits hot gasses to heat the confines of the heat chamber 100. A description of a burner for use with some embodiments is described below. A platform 132 may be provided over the base region 124, so as to overlay the heat source 124 which is disposed in the base region. The top side 121 of the platform 132 may provide, for example, the cooking surface (in implementations in which the heat chamber 100 is an oven).

In one configuration, when operated, heat generated from the heat source 124 extends radially outward towards the sidewalls 122. The platform 132 is structured to guide the hot gasses to the periphery of the interior, before gap formations 115 enable the hot gasses to flow upward at close proximity to the sidewalls 122. In one implementation, the platform 132 has a dimension along the axis X that is slightly less than the corresponding dimension of the interior space 112. The resulting gap formation 115 allows for the hot gasses generated from the heat source 130 to flow upward along the sidewalls 122. In one implementation, the desired effect is that the hot gasses are able to flow at sufficient proximity to the sidewalls 122 to enable boundary layer development of the gas flow with the sidewalls 122.

In alternative configurations, the heat generated from heat source 124 can be cast inward towards, for example, the back wall of the oven (in the orientation shown, the back wall would be on the plane of the paper). Thus, for example, the gap formation 115 and platform 132 may be oriented to enable vertical airflow at the back wall, rather than the side wall 122.

The chamber 100 may also incorporate one or more exhaust elements. In the implementation shown, exhaust 119 is positioned centrally at the base of the oven.

According to some embodiments, the interior of the heat chamber 100 is formed from material that has the following characteristics: (i) low dimensional expansion/contraction, (ii) ability to withstand high temperatures and heating/cooling cycles, (iii) eliminate impurities such as lime in the walls of the oven, which can break off or crack. In one embodiment, the material that forms the interior of the heat chamber 100 is comprised of cementitious, hydraulic, refractory, ceramic material. In one implementation, the product base includes calcium aluminate cement, formed from mixture with water that is fired at high temperature for several hours or days and then returned to room temperature (such a process burns off organic impurities and water). At sufficient high temperature and duration, sintering occurs and constituent materials bond to each other forming a new material. This new material has a low coefficient of thermal expansion and is resistant to high temperatures. The interior of the heat chamber 100 can further be formulated from tiles, with low porosity and minimal or non-existing grout lines.

According to some embodiments, the sidewalls 122 include surface features or structures to cause turbulization as between the hot gas and the sidewalls 122, in order to enhance the heat transfer between gas and surface. In some embodiments, the sidewalls 122 include structures or texture to cause the gas flow along the sidewalls to be turbulent. The structures or texture may be in the form of, for example, grooves, bumps or other protrusions. As alternatives or variations, the structures or texture may be in the form of recesses or indentations. Such structures or texture prevent the boundary layer of the hot gas stream rising up the walls from detaching as the gas rises. The wall texture creates just the right amount of turbulence to maintain boundary layer contact. This results in even heat flow into the walls along its entire surface.

Embodiments recognize that the interaction between the gas and sidewalls 122 enhances efficiency based on principles of Fourier law. According to Fourier's law, the heat flow from a gas to a solid surface depends primarily on: (i) the temperature difference between the gas and the surface of the sidewalls 122, and (ii) and the heat transfer co-efficient between the sidewall 122 and the hot gas. Fourier's law dictates that heat flow increases with increase of each of (i) or (ii), although not at the same rate. In recognition of this phenomena, embodiments include structures that are arranged vertically along the sidewalls 122, and which turbulize the flow of hot gas in a manner that decreases the temperature difference (by first cooling the gasses) and increasing the heat transfer co-efficient (by increasing the gas velocity). The result is a faster heat transfer rate.

By directing the flow of hot gas along the sidewalls 122, the heat exchange between the gas flow and surface occurs with greater efficiency. Additionally, to achieve energy exchange with maximum efficiency, the hot gasses that pass in proximity to the sidewalls 122 are cooler in temperature than would otherwise be required with conventional heating techniques. This results in greater efficiency of the heat exchange process.

### Heat Source

Various heat sources and designs may be used in combination with a heat chamber 100 such as shown and described by various embodiments. In one embodiment, the heat source 130 corresponds to an electrical heating system that includes one or more heating elements that are arranged in the base of the oven. In another embodiment, the heat source 130 corresponds to a combustor that generates hot gas flow in a manner that enables turbulization. In alternative implementations, other kinds of heat sources may be used.

In an embodiment, the heat source 130 includes a blower 136 and a mixing chamber 138 for air and fuel. The hot gas is driven out of the heat source 130 and into the interior region 112 of the chamber 100. In one embodiment, mixing chamber 138 is structured to enable a cross mixing and combustion between air driven by the blower 136 and fuel passing through the mixing chamber 138, with the air and the fuel interacting orthogonally. In one embodiment, the mixing chamber 138 includes a conical geometry that provides for air inlets 139 along a base region 141. The inlets 139 are aligned to receive forced air from the blower 136. Fuel is received from the fuel inlet 143, which in the implementation of FIG. 1C, is positioned at the end of the mixing chamber. A fuel diffuser 149 may be positioned to distribute the fuel radially within the mixing chamber 138. The orientation of the inlets 139 relative to the flow of fuel from the inlet 143 causes the air and fuel to interact orthogonally. The orthogonal interaction further enhances mixing of fuel and air.

In operation, the heat source 130 is configured to utilize combustion to distribute gases from a distribution source within the base region 124. The outflow of mixing chamber 138 may be directed at a structure 128 that distributes the hot gas directionally as desired. For example, in the implementation shown, the structure 128 directs the airflow radially outward towards the side walls 122. As an addition or alternative, the structure 128 can direct the airflow towards a back wall of the chamber (in variations in which the chamber is configured to direct the airflow upwards at the back chamber).

In some implementations, structure 128 can also turbulize the airflow. In one implementation, the structure 128 is formed off of an underside 133 of the platform 132, and provides a primary mechanism for turbulizing the outflow of hot gasses from the mixer 138. The structure 128 can be of a variety of shapes and configurations in order to enhance distribution and/or turbulization. In one implementation, the structure 128 includes a conical (or rounded cone) formation that directs the heated gas into a contoured base (e.g., a juicer configuration), where the gas can flow in a circular pattern (with respect to X and Y axes) while being distributed in the region 124. Numerous other structures may optionally be used to turbulize and/or distribute the heated gasses that are output from the mixer 138. In some embodiments, the outflow from the heat source 130 includes a gas mixing torus that enhances the mixing of gas and air to enhance the combustion efficiency. The gas distribution extends to the sidewalls 122, where the gap formations enable the gas to flow upwards and hear the sidewalls 122.

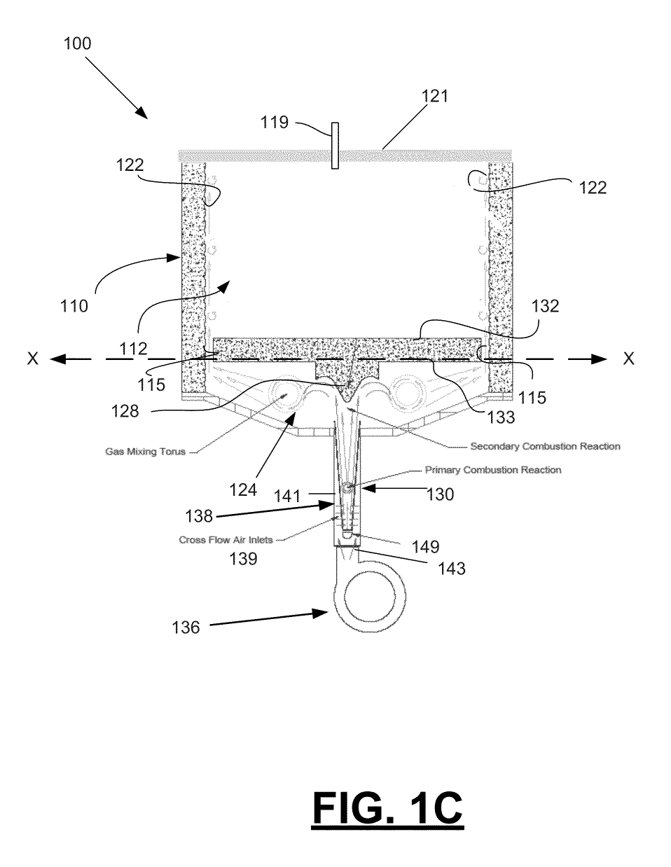

FIG. 2 is a side view of the heat source 130, according to one or more embodiments. The heat source 130 includes blower 136 and mixing chamber 138. The mixing chamber 138 includes a cylindrical housing 222 that retains an inverted conical combustion chamber 224. The diffuser 143 (FIG. 1) is positioned at the end of the conical combustion chamber 224. The diffuser 143 may be mated with a fuel inlet 226 which receives the fuel for combustion.

In one embodiment, the combustion chamber 224 is perforated to include air inlets 139 that are positioned along a portion of its exterior surface. The positioning of the air inlets 139 enables orthogonal entry (or substantial orthogonal entry) of forced air from the blower 136. In one implementation, the air inlets 139 are structured so that the forced air from the blower 136 enters the mixing chamber in an orthogonal direction. A hot surface igniter (not shown) is positioned to ignite the fuel within the combustion chamber 224. The design of the heat source 130 enables a combustion reaction that is sheathed in moving air. As a result, the heat source 130 remains relatively cool, and further enhances efficiency of the heat exchange process.

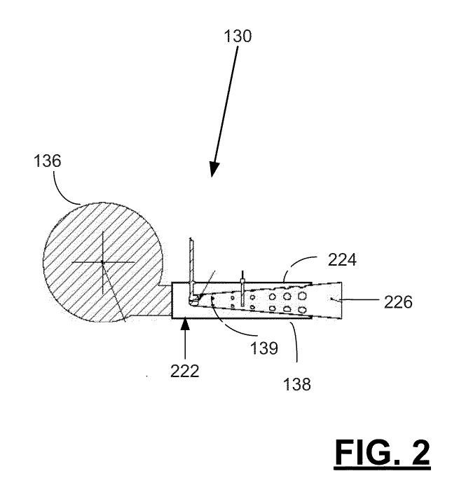

Among other attributes, embodiments structure the heat source 130 to be capable of (i) adjusting both heat rate and gas temperature on the fly via a control system or module (see FIG. 3); (ii) producing large range of temperature output; (iii) being efficient in use of fuel; and (iv) reducing or eliminating gasses free of unwanted gasses such as NOx and CO.

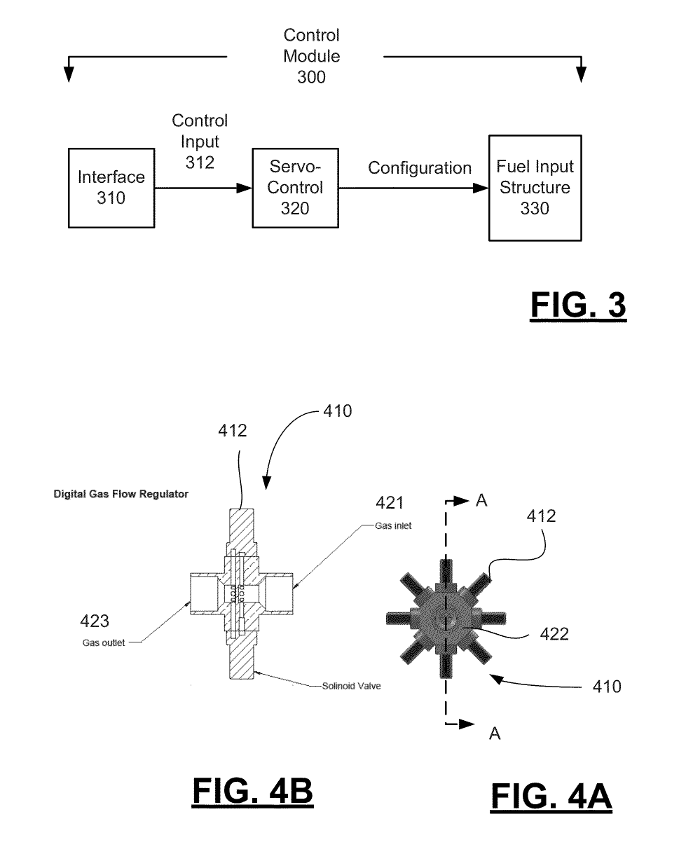

FIG. 3 illustrates a control system for a combustor such as shown and described with FIG. 1C and FIG. 2, according to another embodiment. A control system 300 for the heat source 130 (see FIG. 1C and FIG. 2) includes an interface 310, a servo-control 320, and a variable fuel input structure 330. The input structure 330 (or solenoid structure) may be implemented in accordance with an embodiment such as described with FIG. 4A and FIG. 4B. In one embodiment, the control system 300 programmatically controls the variable valve fuel input structure 330.

The servo-control mechanism 320 may be controlled by control input 312, received from interface 310, and operates to configure the solenoid structure 330. The interface 310 may be user-operated. As an alternative, the interface 310 may be operated programmatically, through, for example software or firmware. For example, control input 312 may be generated through pre-determined settings that are programmed via the interface 310.

The variable valve fuel input 310 can be used to control the output of the heat source 130, and thus the temperature of the heat chamber 100. The control system 300 may be implemented with, for example, a user-interface that enables an operator to control the temperature with fuel input. In variations, the user interface may be provided on or with the heat chamber 100, or alternatively, provided through a computer interface that connects to the variable valve fuel input 310. Such a computer interface may be provided on any computing device (e.g. laptop, tablet, smart phone) that can connect directly to the mechanical interface.

The variable fuel input structure 330 can be implemented in anyone of a variety of designs. For example, the variable fuel input structure 330 can be implemented as a combination of servo controlled mechanical valves that are programmatically controlled by on-board logic or software. FIG. 4A and FIG. 4B illustrate an embodiment in which the variable fuel input structure 330 includes a solenoid structure, according to an embodiment. FIG. 4A is a top view of a solenoid structure 410, illustrating a series of solenoids 410 that extend from a centralized hub 422. FIG. 4B is a side cross-sectional view of the solenoid structure of FIG. 4A, as viewed along A-A. The solenoid structure 410 can be implemented as a series (e.g. 8 currently) of solenoid valves 412 that are integrated into the hub 422 having a fuel inlet 421 and outlet. Each valve 412 can include a different orifice dimension through which fuel flows. The result is that the output through the outlet 423 can be adjusted based on the input and valve orientation. The solenoid structure 410 may receive fuel input and/or configure outputs fuel flow based on its configuration. The solenoid configuration can include configurations that set in orifice dimension. For example, as shown by the figures, the orifice dimensions may be set by a combination of solenoids that are individually operated based in configuration settings provided through a control mechanism. In one implementation, for example, eight solenoid valves 412 can be combined to produce 256 different fuel rates. The mechanical interface (not shown) can be used to control the valve orientation based on user input through, for example, the computer interface.

### Alternatives and Variations

While the chamber 100 and the heat source 130 are depicted in the accompanying figures as comprising a system, various embodiments enable each of the components to be used in separate environments or applications. In particular, the heat chamber 100 such as depicted in FIG. 1 may be implemented with alternative combustors. Likewise, the heart source 130 of FIG. 2 and FIG. 3 may be used to heat spaces and chambers other than one designed in accordance with embodiments described herein.

### Conclusion

Embodiments described herein include individual elements and concepts described herein, independently of other concepts, ideas or systems, as well as combinations of elements recited anywhere in this application. Although illustrative embodiments of the invention have been described in detail with reference to the accompanying drawings, it is to be understood that the described embodiments are not limited to those precise embodiments, but rather include modifications and variations as provided. Furthermore, a particular feature described either individually or as part of an embodiment can be combined with other individually described features, or parts of other embodiments, even if the other features and embodiments make no mention of the particular feature.

What is claimed is:

1. A heat chamber comprising:
a plurality of segments that define an interior;
a heat source to heat the interior;
wherein each of the plurality of segments are formed from a composite that is able to be heated, substantially across a thickness of that segment, to a temperature that is substantially equivalent to a temperature of the interior when the interior is heated by the heat source.

2. The heat chamber of claim 1, wherein the segments are formed a composite that irradiates the interior when heated to the substantially equivalent temperature.

3. The heat chamber of claim 1, wherein the plurality of segments are each monolithic.

4. The heat chamber of claim 1, wherein the plurality of segments are each molded from the composite so as to be substantially uniform in composition across the respective thickness of that segment.

5. The heat chamber of claim 1, wherein each of the plurality of segments includes cement and one or more additives selected from a group consisting of amorphous silica, silica fume, basalt, sillimanite, corundum, or vermiculite.

6. The heat chamber of claim 1, wherein each of the plurality of segments comprises silica and cement.

7. The heat chamber of claim 6, wherein each of the plurality of segments comprises amorphous silica.

8. The heat chamber of claim 6, wherein each of the plurality of segments comprises 75-85% amorphous silica and 15-25% cement.

9. The heat chamber of claim 8, wherein each of the plurality of segments includes austenite.

10. The heat chamber of claim 1, wherein the temperature of one or more of the plurality of segments heats uniformly across a thickness of that segment, along at least a portion of a length that partially defines the interior.

11. The heat chamber of claim 1, wherein one or more of the segments include or provide structures which directionally orient radiant energy emitted from that segment.

12. The heat chamber of claim 1, wherein the heat source is electrical.

13. The heat chamber of claim 1, wherein the heat source is gas-fueled.

14. The heat chamber of claim 1, wherein the heat source is positioned at a base of the heat chamber, below a floor where an object that is to be heated is to be located.

15. The heat chamber of claim 1, wherein the plurality of segments include one or more segments that include a castable thickness that comprises the composite.

16. The heat chamber of claim 15, wherein the one or more segments include one or more layers of insulation, a ventilation thickness, and an exterior skin.

17. The heat chamber of claim 16, wherein the castable thickness is structured to heat to a temperature that is substantially equivalent to the temperature of the interior, and wherein the one or more layers of insulation and the ventilation thickness are structured to maintain a temperature of the exterior skin at below 150° F. (65.56 degree Celsius) when the temperature of the interior is above 900° F. (482.2 degree Celsius).

18. A segment for a heat chamber, the segment comprising:
a castable material;
one or more layers of insulation; and
an exterior skin.

19. The segment of claim 18, further comprising a ventilation thickness positioned on an interior of the exterior skin.

20. A heat chamber formed from a plurality of monolithic pieces, each of the monolithic pieces being comprised of castable material.
